(19) United States
(12) Patent Application Publication
(10) Pub. No.: US 2019/0212519 A1
(43) Pub. Date: Jul. 11, 2019

(54) OPTICAL DEVICE

(71) Applicant: SHARP KABUSHIKI KAISHA, Sakai City, Osaka (JP)

(72) Inventors: SHOHGO HIROOKA, Sakai City (JP); YOSHIHITO ISHIZUE, Sakai City (JP); YOSHIKAZU OHARA, Sakai City (JP)

(21) Appl. No.: 16/333,929

(22) PCT Filed: Oct. 5, 2017
(86) PCT No.: PCT/JP2017/036298

§ 371 Date: Mar. 15, 2019

(30) Foreign Application Priority Data
Oct. 14, 2016 (JP) 2016-203017

(51) Int. Cl. G02B 7/02; G02B 5/20; G02B 13/18; H04N 5/225

(52) U.S. Cl. CPC G02B 7/02; G02B 5/208; H04N 5/2254; H04N 5/2253; G02B 13/18

(57) ABSTRACT

[Object] To enable mounting of a lens onto a light-receiving element with high accuracy while achieving a reduction in the profile of an optical device.

[Solution] An optical device (101) includes an adhesive (6) that joins a sensor (2) and a lens (3) to each other.

### TECHNICAL FIELD

The present invention relates to an optical device.

### BACKGROUND ART

Recently, optical devices, which are represented by camera modules, optical detectors, optical range finders, and the like, that include a sensor (light-receiving element) have been required to have a low profile.

PTL 1 proposes a technology of forming an opening, to reduce the profile of an optical device that includes a substrate, a sensor, and a lens, in the substrate and disposing the lens in the opening. In the technology proposed in PTL 1, the lens disposed in the opening is fixed to the substrate.

### CITATION LIST

### Patent Literature

PTL 1: International Publication No. 2015-151697 (published on 8 Oct. 2015)

### SUMMARY OF INVENTION

### Technical Problem

The lens according to the technology proposed in PTL 1 is fixed indirectly (that is, via the substrate) to the sensor. Therefore, in the technology proposed in PTL 1, there occurs a problem in which it is difficult to mount the lens onto the sensor with high accuracy.

The present invention is made in consideration of the aforementioned problem. An object of the present invention is to provide an optical device that enables a lens to be easily mounted onto a light-receiving element with high accuracy while achieving a reduction in the profile of the optical device.

### Solution to Problem

To solve the aforementioned problem, an optical device according to one aspect of the present invention includes a substrate in which an opening is formed, a light-receiving element that has a light-receiving portion and that is disposed so as to close the opening, a lens that is disposed in the opening, and a joining material that joins the light-receiving element and the lens to each other.

### Advantageous Effects of Invention

According to one aspect of the present invention, it becomes easy to mount a lens onto a light-receiving element with high accuracy while achieving a reduction in the profile of an optical device.

### BRIEF DESCRIPTION OF DRAWINGS

FIG. 1 is a sectional view illustrating a schematic configuration of an optical device according to a first embodiment of the present invention.

FIG. 2 is a sectional view illustrating a schematic configuration of an optical device according to a second embodiment of the present invention.

FIG. 3 is a sectional view illustrating a schematic configuration of an optical device according to a third embodiment of the present invention.

FIG. 4 is a sectional view illustrating a schematic configuration of an optical device according to a fourth embodiment of the present invention.

### DESCRIPTION OF EMBODIMENTS

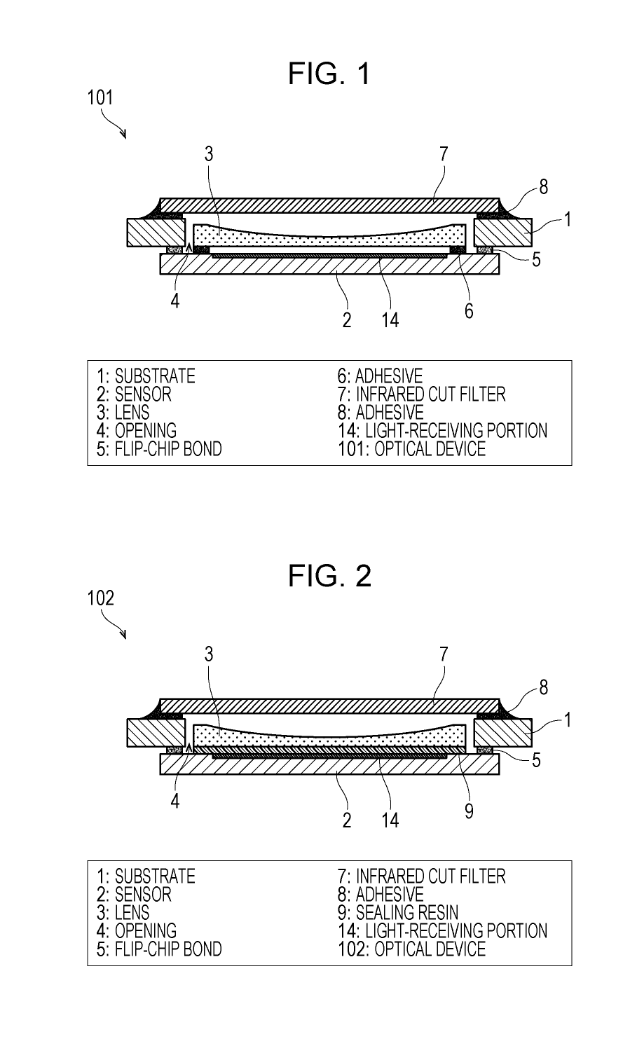

Forms to embody the present invention will be described with reference to FIG. 1 to FIG. 4. For convenience of description, a member having a function identical to that of a previously described member is given a reference sign identical to that of the previously described member and will not be described.

### First Embodiment

FIG. 1 is a sectional view illustrating a schematic configuration of an optical device 101 according to a first embodiment of the present invention. The optical device 101 includes a substrate 1, a sensor 2 (light-receiving element), a lens 3, and an infrared cut filter 7 (covering material).

The substrate 1 is constituted by, for example, ceramic, a glass epoxy, or a fiber-reinforced resin (containing, for example, carbon). In addition, an opening 4 is formed in the substrate 1. The opening 4 is formed so as to extend through the substrate 1.

The sensor 2 is constituted by, for example, CCD (charge coupled device) or a CMOS (complementary metal oxide semiconductor). The sensor 2 is disposed so as to close the opening 4 from the side of the rear surface (lower surface of the substrate 1 in FIG. 1) of the substrate 1. In addition, the sensor 2 has a light-receiving portion 14 on the upper surface (in other words, a surface on an object side) thereof.

The lens 3 is constituted by, for example, plastic or glass. The lens 3 is disposed in the opening 4. The lens 3 is disposed on the object side with respect to the light-receiving portion 14 for the purpose of converging and diffusing light by refracting the light with respect to the light-receiving portion 14. Referring to FIG. 1, the lens 3 has a concave aspherical surface on the object side and has a flat surface or a substantially flat surface on the side of the sensor 2 (image surface side). Note that the shapes of the two surfaces of the lens 3 are not limited thereto. For example, the surface of the lens 3 on the side of the sensor 2 may be an aspherical surface.

The infrared cut filter 7 is disposed on the object side with respect to the lens 3. Specifically, the infrared cut filter 7 is disposed on a side opposite to the sensor 2 with the lens 3 as a reference so as to cover the opening 4. The infrared cut filter 7 is disposed for the purpose of preventing infrared rays from entering the lens 3 and the light-receiving portion 14 and has a function of blocking infrared rays with respect to light that has entered the infrared cut filter 7.

The substrate 1 and the sensor 2 are joined and electrically connected to each other by a flip-chip bond 5.

The optical device 101 further includes an adhesive 6 (joining material) that joins the sensor 2 and the lens 3 to each other. As the adhesive 6, for example, an epoxy-based adhesive or an adhesive that has a function of curing when irradiated with ultraviolet rays is usable. The adhesive 6 joins a surface of the lens on the side of the sensor 2 and a portion around the light-receiving portion 14 to each other.

The infrared cut filter 7 is joined to the substrate 1 by an adhesive 8. As a material of the adhesive 8, the same material as that of the adhesive 6 may be used.

According to the optical device 101, the lens 3 is fixed directly (that is, not via the substrate 1) to the sensor 2 by the adhesive 6. Therefore, the relative positional relation between the sensor 2 and the lens 3 is easily adjusted. Consequently, according to the optical device 101, it becomes easy to mount the lens 3 onto the sensor 2 with high accuracy while achieving a reduction in the profile of the optical device 101.

Existing structures require, as a countermeasure for a problem of foreign materials adhering to the light-receiving portion 14 of the sensor 2, disposing the infrared cut filter 7 directly on the light-receiving portion 14 for the purpose of covering the light-receiving portion 14.

In contrast, the optical device 101 has a structure in which foreign materials do not easily adhere directly to the light-receiving portion 14 because the sensor 2 and the lens 3 are joined to each other. As a result, the infrared cut filter 7 may be disposed anywhere in the optical device 101 without giving consideration to countermeasures for foreign materials. Therefore, according to the aforementioned configuration, design flexibility of the optical device is increased. In a specific example, the infrared cut filter 7 is not required to be disposed on the substrate 1. For example, it becomes possible to include the infrared cut filter 7 in an upper lens group (not illustrated) that is disposed on the object side with respect to the optical device 101.

The infrared cut filter 7 may be substituted with, for example, a bandpass filter.

### Second Embodiment

FIG. 2 is a sectional view illustrating a schematic configuration of an optical device 102 according to a second embodiment of the present invention. The configuration of the optical device 102 differs from the configuration of the optical device 101 (refer to FIG. 1) in terms of a sealing resin 9 (joining material) being included as an alternative to the adhesive 6.

The sealing resin 9 has a function of sealing a gap between the sensor 2 and the lens 3 in addition to a function of joining the sensor 2 and the lens 3 to each other. The sealing resin 9 is constituted by a resin that has light-transmitting properties.

According to the optical device 102, it is possible to join the sensor 2 and the lens 3 to each other more strongly compared with the optical device 101. In addition, according to the optical device 102, there is no need to consider outflow of the sealing resin 9 to the light-receiving portion 14 because the sealing resin 9 is intentionally disposed on the entirety of the light-receiving portion 14, which requires no leakage preventing mechanism for preventing the outflow. Consequently, the design of the optical device is simplified compared with that when a leakage preventing mechanism is provided, and it becomes possible to reduce the costs and the manufacturing period of the optical device.

### Third Embodiment

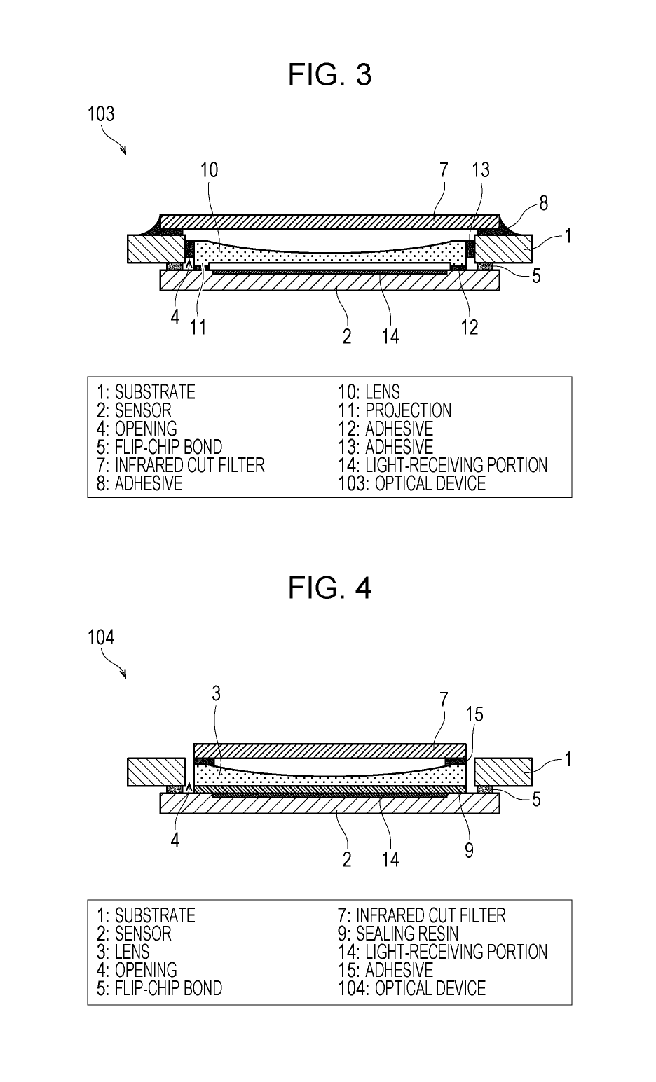

FIG. 3 is a sectional view illustrating a schematic configuration of an optical device 103 according to a third embodiment of the present invention. The configuration of the optical device 103 differs from the configuration of the optical device 101 (refer to FIG. 1) in terms of a lens 10 being included as an alternative to the lens 3. In addition, the configuration of the optical device 103 differs from the configuration of the optical device 101 in terms of an adhesive 12 and an adhesive 13 being included as an alternative to the adhesive 6.

The configuration of the lens 10 differs from the configuration of the lens 3 in terms of a projection 11 being formed on a surface of the lens 10 on the side of the sensor 2. The lens 10 is joined at the projection 11 to the sensor 2 by the adhesive 12. The adhesive 13 joins a side surface of the lens 10 and an inner wall of the opening 4 to each other. As a material of each of the adhesive 12 and the adhesive 13, the same material as that of the adhesive 6 may be used.

According to the optical device 103, the lens 10 is fixed directly to the sensor 2 by the adhesive 12, and the lens 10 is fixed directly to the substrate 1 by the adhesive 13. Therefore, according to the optical device 103, it is possible to fix the substrate 1 and the lens 10 to each other, and it becomes easy to mount the lens 10 onto the substrate 1 with high accuracy compared with the optical device 101.

In the configuration of the optical device 103, the lens 3 may be used as an alternative to the lens 10. In this case, the lens 3 is joined to the sensor 2 by the adhesive 6 illustrated in FIG. 1 or by the sealing resin 9 illustrated in FIG. 2, and a side surface of the lens 3 and the inner wall of the opening 4 are joined to each other by the adhesive 13. In other words, the projection 11 may be omitted.

### Fourth Embodiment

FIG. 4 is a sectional view illustrating a schematic configuration of an optical device 104 according to a fourth embodiment of the present invention. The configuration of the optical device 104 differs from the configuration of the optical device 102 (refer to FIG. 2) in terms of an adhesive 15 being included as an alternative to the adhesive 8.

The adhesive 15 joins the lens 3 and the infrared cut filter 7 to each other. As a material of the adhesive 15, the same material as that of the adhesive 6 may be used. As illustrated in the optical device 104, the lens 3 and the infrared cut filter 7 may be joined to each other.

In the optical device 104, the infrared cut filter 7 is disposed so as not to cover a portion (an open portion between the infrared cut filter 7 and the substrate 1) of the opening 4. Meanwhile, as is the case with the optical device 101 to the optical device 103, the lens 3 and the infrared cut filter 7 may be joined to each other with the adhesive 15 in a state in which the infrared cut filter 7 is disposed so as to cover the entire opening 4.

In addition, the adhesive 8 of the optical device 101 (refer to FIG. 1) or of the optical device 103 (refer to FIG. 3) may be substituted with the adhesive 15.

### Notes

The shape of the aperture of the opening 4 with the optical device 101 in top view is typically a rectangular shape; however, the shape of the aperture is not limited thereto and may be other than a rectangular shape, for example, a circular shape. The same applies to each of the shape of the aperture of the opening 4 with the optical device 102 in top view, the shape of the aperture of the opening 4 with the optical device 103 in top view, and the shape of the aperture of the opening 4 with the optical device 104 in top view.

In addition, the outer shape of the lens 3 in top view is typically a rectangular shape; however, the outer shape of the lens 3 in to view is not limited thereto and may be other than a rectangular shape, for example, a circular shape or a rectangular shape, part of which is notched. The same applies to the outer shape of the lens 10 in top view.

In addition, an end portion of the lens 3 on a side opposite to the sensor 2 (the object side) typically does not protrude from a surface of the substrate 1; however, the end portion of the lens 3 is not limited thereto and may protrude from the surface of the substrate 1. In other words, a portion of the lens 3 may be present at a position higher than the surface of the substrate 1. The same applies to an end portion of the lens 10 on a side opposite to the sensor 2.

In addition, the infrared cut filter 7 is typically disposed above the substrate 1 but may be disposed in the opening 4.

In addition, a clearance in accordance with a difference between the size of the opening 4 and the size of the lens 3 is typically formed between the substrate 1 and the lens 3; however, such a clearance may not be formed. The same applies to a clearance between the substrate 1 and the lens 10.

Moreover, each of the optical device 101 to the optical device 104 is applicable to a camera module, an optical detector, an optical range finder, and the Like.

### Overview

An optical device according to a first aspect of the present invention includes a substrate in which an opening is formed, a light-receiving element (the sensor 2) that has a light-receiving portion and that is disposed so as to close the opening, a lens that is disposed in the opening, and a joining material (the adhesive 6, the sealing resin 9, or the adhesive 12) that joins the light-receiving element and the lens to each other.

According to the aforementioned configuration, the lens is fixed directly (that is, not via the substrate) to the light-receiving element by the joining material. Therefore, the relative positional relation between the light-receiving element and the lens is easily adjusted. Consequently, according to the aforementioned configuration, it becomes easy to mount the lens onto the light-receiving element with high accuracy while achieving a reduction in the profile of the optical device.

An optical device according to a second aspect of the present invention is the optical device in the first aspect in which the joining material is a sealing resin that seals a gap between the light-receiving element and the lens.

According to the aforementioned configuration, it is possible to join the light-receiving element and the lens to each other more strongly. In addition, according to the aforementioned configuration, there is no need to consider outflow of the sealing resin to the light-receiving portion because the sealing resin is intentionally disposed on the light-receiving portion, which requires no leakage preventing mechanism for preventing the outflow. Consequently, the design of the optical device is simplified compared with that when a leakage preventing mechanism is provided, and it becomes possible to reduce the costs and the manufacturing period of the optical device.

In addition, an optical device according to a third aspect of the present invention is the optical device in the first aspect or the second aspect in which the substrate and the lens are joined to each other.

According to the aforementioned configuration, the lens is fixed directly to the substrate. Therefore, according to the configuration, it is possible to fix the substrate and the lens to each other, and it becomes easy to mount the lens onto the substrate with high accuracy.

In addition, an optical device according to a fourth aspect of the present invention is the optical device in any of the first to third aspects, the optical device including a covering material (the infrared cut filter 7) that is disposed on a side opposite to the light-receiving element with the lens as a reference so as to cover the opening.

According to the aforementioned configuration, the optical device has a structure in which foreign materials do not easily adhere directly to the light-receiving portion because the light-receiving element and the lens are joined to each other. As a result, according to the aforementioned configuration, the covering material may be disposed anywhere in the optical device without giving consideration to countermeasures for foreign materials. In other words, according to the aforementioned configuration, the design flexibility of the optical device is increased.

In addition, an optical device according to a fifth aspect of the present invention is the optical device in any of the first to third aspects, the optical device including a covering material that is disposed on a side opposite to the light-receiving element with the lens as a reference. The lens and the covering material may be joined to each other.

The present invention is not limited to the embodiments described above and can be variously modified within the scope indicated in the claims. The technical scope of the present invention includes embodiments that are obtained by combining, as appropriate, the technical means disclosed in different embodiments. Further, a technical feature can be newly formed by combining the technical means disclosed in different embodiments.

### REFERENCE SIGNS LIST

1 substrate

2 sensor (light-receiving element)

3 lens

4 opening

5 flip-chip bond

6 adhesive (joining material)

7 infrared cut filter (covering material)

8 adhesive

9 sealing resin (joining material)

10 lens

11 projection

12 adhesive (joining material)

13 adhesive

14 light-receiving portion

15 adhesive

101 to 104 optical device

1. An optical device comprising:
a substrate in which an opening is formed;
a light-receiving element that has a light-receiving portion and that is disposed so as to close the opening;
a lens that is disposed in the opening; and
a joining material that joins the light-receiving element and the lens to each other.

2. The optical device according to claim 1, wherein the joining material is a sealing resin that seals a gap between the light-receiving element and the lens.

3. The optical device according to claim 1, wherein the substrate and the lens are joined to each other.

4. The optical device according to claim 1, the optical device comprising a covering material that is disposed on a side opposite to the light-receiving element with the lens as a reference so as to cover the opening.

5. The optical device according to claim 1, the optical device comprising a covering material that is disposed on a side opposite to the light-receiving element with the lens as a reference, wherein the lens and the covering material are joined to each other.
